(19) United States
(12) Patent Application Publication
(10) Pub. No.: US 2004/0016748 A1
(43) Pub. Date: Jan. 29, 2004

(54) Radiator system, radiating method, thermal buffer, semiconductor module, heat spreader and substrate

(76) Inventors: Kyoichi Kinoshita, Kariya-shi (JP); Takashi Yoshida, Kariya-shi (JP); Tomohei Sugiyama, Kariya-shi (JP); Hidehiro Kudo, Kariya-shi (JP); Eiji Kono, Kariya-shi (JP)

Correspondence Address: MORGAN & FINNEGAN, L.L.P., 345 Park Avenue, New York, NY, 10154, US

(21) Appl. No.: 10/615,432

(22) Filed: Jul. 7, 2003

(30) Foreign Application Priority Data
Jul. 26, 2002 (JP) 2002-218209

(51) Int. Cl. H05B 3/10

(52) U.S. Cl. 219/552; 219/548

(57) ABSTRACT

A radiator system includes a high temperature body being a thermal source, a receiver with the high-temperature body boarded thereon, and a thermal buffer. The receiver receives heat from the high-temperature body. The thermal buffer is interposed at least between the high-temperature body and the receiver to buffer thermal transmission from the high-temperature body to the receiver, includes a high thermal conductor and a low expander disposed at a position facing the high-temperature body and buried in the high thermal conductor, and has a first bonding area with respect to the high-temperature body and a second bonding area with respect to the receiver. The second bonding area is enlarged greater than the first bonding area. The heat from the high-temperature body is radiated by the receiver or is radiated by way of the receiver. Thus, the thermal expansion difference can be minimized between the high-temperature body and receiver.

### BACKGROUND OF THE INVENTION

1. Field of the Invention

The present invention relates to a radiator system, a radiating method and a thermal buffer which relieve thermal stresses generating when heat is transmitted from high-temperature bodies to receivers. Thus, it is possible for the radiator system, radiating method and thermal buffer to secure stable boardability for the high-temperature bodies and receivers. Moreover, the present invention relates to semiconductor modules, heat spreaders and substrates, application forms of the radiator system, radiating method and thermal buffer.

2. Description of the Related Art

Many component parts are heated to high temperatures in service. From the viewpoint of the heat resistance, it is necessary to properly radiate component parts. In particular, electric appliances and electronic appliances comprise devices whose service temperature ranges are regulated strictly. Accordingly, in the electric appliances and electronic appliances, it is important to radiate the devices. Hereinafter, the radiation will be described with reference to an example, a semiconductor module in which semiconductor devices are disposed on a substrate.

Depending on usage of semiconductor modules, semiconductor devices usually generate heat to exhibit high temperatures. In order to ensure that semiconductor devices operate stably, it is indispensable to efficiently radiate them.

Conventionally, heat generated by semiconductor devices have been radiated by boarding semiconductor devices on substrates with high thermal conductivity and disposing heatsinks on the substrates. The more semiconductors are downsized, the higher they are integrated, moreover, the greater the magnitude of currents flowing in semiconductor devices, the more such radiation becomes important.

By the way, semiconductor devices comprise Si, they exhibit such a small linear expansion coefficient as a few ppm's/° C. On the other hand, when substrates on which the semiconductors are boarded are examined for metals, such as Cu, being present in the surface, they exhibit such a large linear expansion coefficient as over 10 ppm/° C. Consequently, when the semiconductor devices and substrates are bonded directly by solder, there might occur such failures that the semiconductor devices are come off from the substrates due to the difference between the linear expansion coefficients.

In order to secure the thermal transmissibility (or radiating property) from semiconductor devices to substrates and the stable boardability (or bondability) of semiconductor devices with respect to substrates, heat spreaders with high thermal conductivity as well as low expandability are proposed to interpose them between the semiconductors and substrates. For example, Japanese Unexamined Patent Publication (KOKAI) No. 2000-77,582 and Japanese Unexamined Utility Model Publication (KOKAI) No. 63-20,448 disclose the heat spreaders. The former publication discloses a heat spreader which comprises a core composed of Cu with high thermal conductivity and disposed at the middle, and a frame composed of an invar alloy with low expandability and surrounding the outer periphery of the core. The latter publication discloses a heat spreader in which an invar alloy with low expandability is surrounded by Cu with high thermal conductivity, contrary to the former publication.

In Japanese Unexamined Patent Publication (KOKAI) No. 2000-77,582, the frame (i.e., invar alloy) inhibits the core (i.e., Cu) from thermally expanding. As a result, there might occur that the bonding surfaces of the core which are bonded to the semiconductor devices and substrate swell in the vertical directions. Consequently, the heat spreader might not be able to secure the adhesiveness between the semiconductor device and substrate. Eventually, there might occur such failures that the semiconductor devices are come off from the substrates.

It seems that the heat spreader disclosed in Japanese Unexamined Utility Model Publication (KOKAI) No. 63-20,448 does not suffer from the disadvantage, and that it is good in terms of the thermal conductivity, thermal diffusion effect and bondability. Regardless of the performance of the heat spreader per se, when the heat spreader disclosed in the publication is observed regarding the bonding relationship between the heat spreaders, semiconductor devices and substrate, it is understood that the opposite surfaces of the heat spreaders are bonded to the semiconductor devices and substrate in the same manner. Specifically, the bonding area between the semiconductor devices and heat spreaders little differs from the bonding area between the substrate and heat spreaders.

However, when considering the fact that the linear expansion coefficient of semiconductor devices differs from that of substrates inherently, it cannot necessarily say with any finality that it is reasonable to bond heat spreaders to semiconductor devices as well as to substrates in the same manner, from the viewpoint of the boardability of semiconductor devices with respect to substrates.

### SUMMARY OF THE INVENTION

The present invention has been developed in view of such circumstances. It is therefore an object of the present invention to provide a radiator system, a radiating method and a thermal buffer which can secure the bondability (or boardability) between semiconductor modules, but not limited to the case, and further extensively to the case between high-temperature bodies and receivers which receive heat from the high-temperature bodies. Moreover, it is a further object of the present invention to provide semiconductor modules, heat spreaders and substrates which utilize the radiator system, radiating method and thermal buffer.

The inventors of the present invention have studied wholeheartedly in order to solve the problems. As a result of trial and error over and over again, they thought of varying the above-described bonding areas of heat spreaders, for example, between the device-side bonding area and substrate-side bonding area. They further developed the novel idea to arrive at completing the present invention.

(Radiator System)

A radiator system according to the present invention comprises: a high-temperature body being a thermal source; a receiver with the high-temperature body boarded thereon, the receiver receiving heat from the high-temperature body; and a thermal buffer interposed at least between the high-temperature body and the receiver to buffer thermal transmission from the high-temperature body to the receiver; whereby the heat from the high-temperature body is radiated by the receiver or is radiated by way of the receiver;

wherein the thermal buffer comprises a high thermal conductor, and a low expander disposed at a position facing the high-temperature body and buried in the high thermal conductor; and the thermal buffer has a first bonding area (or high-temperature body-side bonding area) with respect to the high-temperature body, and a second bonding area (or receiver-side bonding area) with respect to the receiver, the second bonding area being enlarged greater than the first bonding area. Especially, the second bonding area can preferably be enlarged greater than the first bonding area in the following manner. For example, in the cross-section of the thermal buffer, the angle formed by a diagonal line, which connects an end of the first bonding area with an end of the second bonding area, and a vertical line, which extends vertically from the end of the first bonding area to the second bonding area, can preferably be 45 deg. or more as illustrated in FIG. 9.

Hereinafter, when the high-temperature body, the receiver and the thermal buffer are considered a semiconductor device, a substrate and a heat spreader, respectively, it is possible to grasp the present radiator system as a semiconductor module. For example, the present invention can be regarded as a semiconductor module, comprising: a semiconductor device being a thermal source; a substrate with the semiconductor device boarded thereon; and a heat spreader interposed between the semiconductor device and the substrate to diffuse heat from the semiconductor device to the substrate;

wherein the heat spreader comprises a high thermal conductor, and a low expander disposed at a position facing the semiconductor device and buried in the high thermal conductor; and the heat spreader has a first bonding area (or device-side bonding area) between the heat spreader and the semiconductor device and with respect to the semiconductor device, and a second bonding area (or substrate-side bonding area) between the heat spreader and the substrate and with respect to the substrate, the second bonding area being enlarged greater than the first bonding area.

Moreover, when the high-temperature body, the receiver and the thermal buffer are considered a semiconductor device, a heatsink and a substrate, respectively, it is possible to grasp the present radiator system as a semiconductor module. For instance, the present invention can be regarded as a semiconductor module, comprising: a semiconductor device being a thermal source; a heatsink receiving heat from the semiconductor; and a substrate having opposite surfaces, bonded to the semiconductor device on one of the opposite surfaces, and bonded to the heatsink on the other one of the opposite surfaces to transmit the heat from the semiconductor device to the heatsink;

wherein the substrate comprises a high thermal conductor, and a low expander disposed at a position facing the semiconductor device and buried in the high thermal conductor; and the substrate has a first bonding area (or device-side bonding area) between the substrate and the semiconductor device and with respect to the semiconductor device, and a second bonding area (or heatsink-side bonding area) between the substrate and the heatsink and with respect to the heatsink, the second bonding area being enlarged greater than the first bonding area.

In addition, when the high-temperature body, the receiver and the thermal buffer are considered a substrate, a heatsink and a heat spreader, respectively, it is possible to grasp the present radiator system as a semiconductor module. For example, the present invention can be regarded as a semiconductor module, comprising: a substrate being a thermal source; a heatsink receiving heat from the substrate; and a heat spreader having opposite surfaces, bonded to the substrate on one of the opposite surfaces, and bonded to the heatsink on the other one of the opposite surfaces to transmit the heat from the substrate to the heatsink;

wherein the heat spreader comprises a high thermal conductor, and a low expander disposed at a position facing the substrate and buried in the high thermal conductor; and the heat spreader has a first bonding area (or substrate-side bonding area) between the heat spreader and the substrate and with respect to the substrate, and a second bonding area (or heatsink-side bonding area) between the heat spreader and the heatsink and with respect to the heatsink, the second bonding area being enlarged greater than the first bonding area.

(Radiating Method)

Not limited to the above-described present radiator system, it is possible to grasp the present invention as a radiating method. For instance, the present invention can be regarded as a radiating method for radiating heat from a high-temperature body being a thermal source by a receiver with the high-temperature body boarded thereon, the receiver receiving the heat from the high-temperature body, or radiating the heat by way of the receiver, the radiating method comprising the step of: preparing a thermal buffer interposed at least between the high-temperature body and the receiver to buffer thermal transmission from the high-temperature body to the receiver, wherein the thermal buffer comprises a high thermal conductor, and a low expander disposed at a position facing the high-temperature body and buried in the high thermal conductor; and the thermal buffer has a first bonding area (or high-temperature body-side bonding area) with respect to the high-temperature body, and a second bonding area (or receiver-side bonding area) with respect to the receiver, the second bonding area being enlarged greater than the first bonding area.

(Thermal Buffer)

Further, not limited to the above-described present radiator system, it is possible to grasp the present invention as a thermal buffer. For example, the present invention can be regarded as a thermal buffer interposed at least between a high-temperature body being a thermal source and a receiver with the high-temperature body boarded thereon, the receiver receiving heat from the high-temperature body, to buffer thermal transmission from the high-temperature body to the receiver,

wherein the thermal buffer comprises a high thermal conductor, and a low expander disposed at a position facing the high-temperature body and buried in the high thermal conductor; and the thermal buffer has a first bonding area (or high-temperature body-side bonding area) positioned with respect to the high-temperature body, and a second bonding area (or receiver-side bonding area) positioned with respect to the receiver, the second bonding area being enlarged greater than the first bonding area.

Hereinafter, when the high-temperature body and the receiver are considered a semiconductor device and a substrate, respectively, it is possible to grasp the above-described present thermal buffer as a heat spreader. For instance, the present invention can be regarded as a heat spreader interposed between a semiconductor device being a thermal source and a substrate with the semiconductor device boarded thereon to diffuse heat from the semiconductor device to the substrate,

wherein the heat spreader comprises a high thermal conductor, and a low expander disposed at a position facing the semiconductor device and buried in the high thermal conductor; and the heat spreader has a first bonding area (or device-side bonding area) between the heat spreader and the semiconductor device and with respect to the semiconductor device, and a second bonding area (or substrate-side bonding area) between the heat spreader and the substrate and with respect to the substrate, the second bonding area being enlarged greater than the first bonding area.

Furthermore, when the high-temperature body and the receiver are considered a semiconductor device and a heatsink, respectively, it is possible to grasp the above-described present thermal buffer as a substrate. For example, the present invention can be regarded as a substrate having opposite surfaces, bonded to a semiconductor device being a thermal source on one of the opposite surfaces, and bonded to a heatsink receiving heat from the semiconductor device on the other one of the opposite surfaces to transmit the heat from the semiconductor device to the heatsink,

wherein the substrate comprises a high thermal conductor, and a low expander disposed at a position facing the semiconductor device and buried in the high thermal conductor; and the substrate has a first bonding area (or a device-side bonding area) between the substrate and the semiconductor device and with respect to the semiconductor device, and a second bonding area (heatsink-side bonding area) between the substrate and the heatsink and with respect to the heatsink, the second bonding area being enlarged greater than the first bonding area.

Moreover, when the high-temperature body and the receiver are considered a substrate and a heatsink, respectively, it is possible to grasp the above-described present thermal buffer as a heat spreader. For instance, the present invention can be regarded as a heat spreader having opposite surfaces, bonded to a substrate being a thermal source on one of the opposite surfaces, and bonded to a heatsink receiving heat from the substrate on the other one of the opposite surfaces to transmit the heat from the substrate to the heatsink,

wherein the heat spreader comprises a high thermal conductor, and a low expander disposed at a position facing the semiconductor device and buried in the high thermal conductor; and the heat spreader has a first bonding area (or substrate-side bonding area) between the heat spreader and the substrate and with respect to the substrate, and a second bonding area (or heatsink-side bonding area) between the heat spreader and the heatsink and with respect to the heatsink, the second bonding area being enlarged greater than the first bonding area.

Note that the above-described heat spreader according to the present invention can take on not only a simple thermal diffusing function but also the functions of heatsink. Further, wherever appropriate, a heat spreader interposed between a semiconductor device and a substrate will be hereinafter referred to as a device-side heat spreader, and a heat spreader interposed between a substrate and a heatsink will be hereinafter referred to as a substrate-side heat spreader. Furthermore, a heatsink can be simple metallic plates whose major component is Cu or Al. The heatsink can constitute the entire enclosure of semiconductor modules or a part of the enclosure as well. Moreover, it is possible to use liquid-cooled heatsinks in which a coolant (e.g., cooling water) is held or flowed to enhance the cooling efficiency.

In addition, the wording, such as “boarded,” is used in the present specification. Note that, however, the wording does not directly restrain the positional relationships between the high-temperature body and receiver, and the like. For example, it does not matter whether the high-temperature body and receiver are disposed in a vertical manner, a horizontal manner, and so forth. Still further, intervening objects can be present between the high-temperature body and receiver.

The above-described semiconductor modules are some examples which further embody the present invention. Specifically, the semiconductor modules are exemplified in which either one of the heat spreader and substrate is used as the thermal buffer. However, it is possible to constitute semiconductor modules, and the like, by properly applying the present thermal buffer to a plurality of component members, such as the device-side heat spreader, substrate and substrate-side heat spreader.

Hereinafter, the operations and advantages of the present invention will be described more specifically while exemplifying a semiconductor in which the present thermal buffer is used as a heat spreader. In the present semiconductor module, not limited to the heat spreader in which the low expander is buried in the high thermal conductor is used, the respective bonding areas between the heat spreader and semiconductor module as well as between the heat spreader and substrate are arranged appropriately. Accordingly, while securing the thermal diffusion property and radiation property, it is also possible to secure the more stable boardability of the semiconductor device with respect to the substrate. Specifically, as described above, the substrate-side bonding area (or second bonding area) is enlarged greater than the device-side bonding area (or first bonding area). It is not necessarily definite why the arrangement further stabilizes the boardability of the semiconductor device with respect to the substrate. However, it is believed as follows. Here, in order to simplify the explanation, the case in which the low expander is buried in the middle of the high thermal conductor in the vertical cross-section will be described in an exemplifying manner.

The linear expansion coefficient of semiconductor devices is small generally, and the thermal expansion magnitude is also small. On the other hand, substrates with semiconductors boarded thereon comprise metals, such as Cu, adjacent to the surface at least, and the linear expansion coefficient is great, and accordingly the thermal expansion magnitude is also great. Based on these facts, it is ideal that heat spreaders exhibit a thermal expansion magnitude close to that of semiconductor devices on the device-side bonding surface, and exhibit a thermal expansion magnitude close to that of substrates on the substrate-side bonding surface, because heat spreaders interposed between them absorb and relieve the linear thermal expansion difference between them. Namely, it is required that the thermal expansion magnitude be less comparatively on the device-side bonding surface of heat spreaders, and the thermal expansion magnitude be great comparatively on the substrate-side bonding surface of heat spreaders.

Next, let us consider the case in which semiconductor devices are heated to high temperatures by using semiconductor modules and the temperature of heat spreaders enters the stable period from the transitional period. In other words, let us consider the case in which heat spreaders show a substantially uniform temperature as a whole. In this instance, when heat spreaders are observed independently, it seems that the overall thermal expansion magnitude is substantially equal on the device-side bonding surface as well as on the substrate-side bonding surface, as far as the low expander is buried in the middle of the high thermal conductor. However, when the distribution of local thermal expansion magnitudes is observed, the thermal expansion magnitude of heat spreaders should be reduced in the vicinity of the low expander due to the restraint by the low expander. Hence, like the present semiconductor modules, when semiconductor devices are bonded to the local area of heat spreaders where the thermal expansion magnitude is reduced due to the restraint by the low expander, it is possible to reduce the thermal expansion difference between the heat spreaders and semiconductor devices. On the contrary, let us observe heat spreaders as a whole, when substrates are bonded to the wide area of heat spreaders where heat spreaders exhibit an enlarged thermal expansion magnitude, it is possible to reduce the thermal expansion difference at the bonding surface between the heat spreaders and substrates as well.

The semiconductor module which uses the present thermal buffer as the heat spreader has been described so far. However, it is possible to believe that a semiconductor module which uses the present thermal buffer as the substrate operates and effects advantages in the same manner. Moreover, not limited to semiconductor modules, the situations are similarly applicable to three-layered structures which comprise a high-temperature body, a receiver and a thermal buffer interposed between the high-temperature body and receiver. In addition, the case where the low expander is buried in the middle of the high thermal conductor is exemplified to describe the present invention. However, it is natural that the present invention is not limited to the arrangement. For example, the closer the low expander is disposed with respect to the high-temperature body (e.g., semiconductor devices), the more the thermal expansion differences between the high-temperature body and thermal buffer (e.g., heat spreaders or substrates) and between the thermal buffer and receiver (e.g., substrates or heatsinks) are diminished.

As far as the lower expander is disposed at a position facing the high-temperature body, it can be the same size (or breadth) as the bonding surface of the high-temperature body, or it can have sizes which differ therefrom. Moreover, the one and only low expander can be buried in the high thermal conductor, or can be divided into pieces and be buried therein. In addition, it is possible to control the thermal expansion magnitude of the thermal buffer not only by adjusting the disposition of the low expander in the thermal buffer, but also by adjusting the volumetric occupying proportion of the low expander therein. For example, when the volumetric occupying proportion of the low expander is enlarged, it is possible to reduce the thermal expansion magnitude of the entire thermal buffer. When the disposition or volumetric occupying proportion of the low expander in the thermal buffer is thus adjusted, it is possible to more efficiently relieve the thermal expansion difference at the bonding surface between the high-temperature body and receiver.

Indeed, it is needless to say that it is important that the thermal buffer is good in terms of the thermal conductivity, because the thermal buffer diffuses or radiates the heat from the high-temperature body to the receiver effectively. The high thermal conductor in which the low expander is buried is in charge of the function. Hence, it is suitable that the thermal buffer can comprise the high thermal conductor, and the low expander which is buried in the high thermal conductor and whose outer peripheral surface is surrounded by the high thermal conductor. This because, although the low expander is generally poor in terms of the thermal conductivity, the high thermal conductor provides a great thermal path when the high thermal conductor surrounds the low expander. Not that it is not necessarily required that the high thermal conductor surround the entire outer surface of the low expander completely. For instance, it is acceptable even if the end surfaces of the low expander are not surrounded by the high thermal conductor.

By the way, the low expander according to the present invention can be satisfactory as far as it exhibits a linear expansion coefficient smaller than that of the high thermal conductor. Indeed, in order to further enlarge the degree of freedom in designing the thermal buffer, it is suitable that the low expander can comprise a material whose linear expansion coefficient is smaller than that of the high-temperature body. This is because, with the arrangement, it is possible to relieve the thermal expansion difference between the high-temperature body and receiver more effectively when the disposition, configuration and volumetric occupying proportion of the low expander are adjusted properly. As for such a material for the low expander, an invar alloy is suitable, for example. This is because an invar alloy is less expensive and is good in terms of the formability. Note that, as an invar alloy, there are many invar alloys such as ferromagnetic invar alloys, Fe-based amorphous invar alloys and Fe—Ni-based antiferromagnetic invar alloys in which Cr substitutes for a part of Ni. Taking the service temperature range, processability, cost, being magnetic or nonmagnetic into consideration, it is possible to select invar alloys which are appropriate for the usage of semiconductor modules. Accordingly, in the present invention, the type and composition of invar alloys are not limited in particular. When naming some of the examples, it is possible to use the well-known ferromagnetic invar alloys such as Fe-36% Ni (the unit being % by mass, being the same hereinafter) and Fe-31%-5% Co, a super invar alloy.

The high thermal conductor in which the low expander is buried can be satisfactory, as far as it is better than the low expander in terms of the thermal conductivity. Indeed, in order to assure the good thermal diffusing property as the thermal buffer (as the heat spreaders or substrates in particular), moreover, in view of being less expensive and exhibiting good formability, the high thermal conductor can preferably comprise a pure metal or alloy whose major component is Cu or Al.

Note that the better the receiver is in terms of the thermal conductivity, the more it can be satisfactory. However, it does not matter what sort of materials the receiver is made from. Moreover, the receiver can comprise materials whose thermal expansion magnitude is great. This is because it is possible to comparatively enlarge the thermal expansion magnitude on the receiver-side bonding surface of the thermal buffer according to the present invention. Therefore, the receiver can be satisfactory when it comprises a metallic body with a metallic material base. For instance, in accordance with the present invention, it is possible to utilize not only copper-lined ceramic substrates whose thermal expansion magnitude is less, but also metallic substrates whose thermal expansion magnitude is great, for substrates with semiconductors boarded. Note that metallic substrates are advantageous for reducing the cost of semiconductor modules because metallic substrates are less expensive compared with ceramic substrates.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 is a major vertical cross-sectional view for illustrating a power module according to Example No. 1 of the present invention;

FIG. 2 is a major vertical cross-sectional view for illustrating a power module according to Example No. 2 of the present invention;

FIG. 3 is a major vertical cross-sectional view for illustrating a power module according to Example No. 3 of the present invention;

FIG. 4 is a major vertical cross-sectional view for illustrating a power module according to Example No. 4 of the present invention;

FIG. 5 is a major vertical cross-sectional view for illustrating a power module according to Example No. 5 of the present invention;

FIG. 6 is a major vertical cross-sectional view for illustrating a power module according to Example No. 6 of the present invention;

FIG. 7 is a major horizontal cross-sectional view for illustrating a heat spreader according Example No. 1 of the present invention;

FIG. 8 is a major horizontal cross-sectional view for illustrating a power module according to Example No. 7 of the present invention; and

FIG. 9 is a schematic cross-sectional view for illustrating the areal relationship between a first bonding area and a second bonding area.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLE

Hereinafter, the present invention will be described more specifically with reference to specific examples according to semiconductor modules, an example of the present radiator system.

### Example No. 1

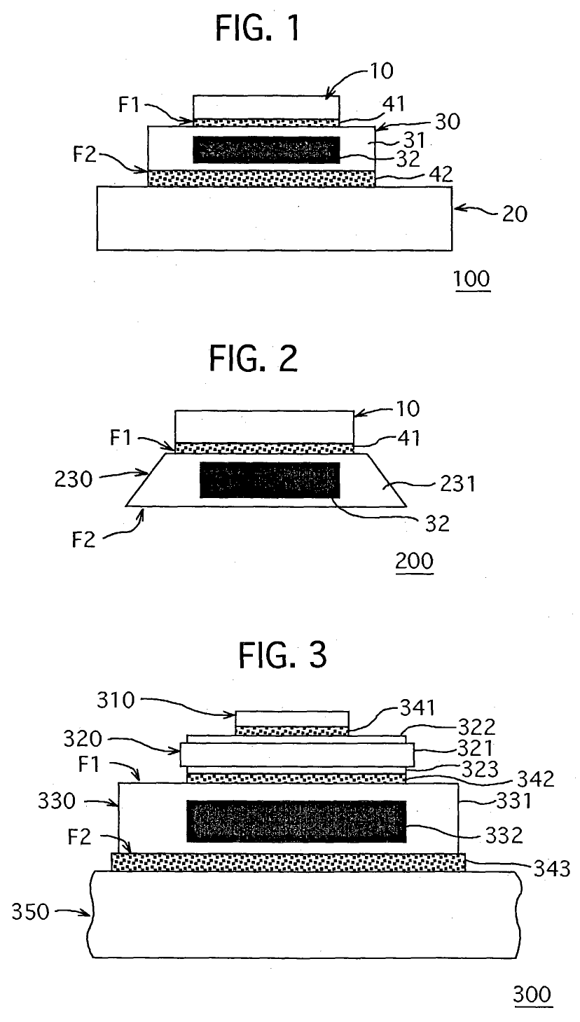

FIG. 1 illustrates a major vertical cross-section of a power module 100 (i.e., semiconductor module) according to Example No. 1 of the present invention. The power module 100 can be used, for example, in inverters for controlling the operations of three-phase induction motors.

The power module 100 comprises semiconductor devices 10, a metallic substrate 20, and heat spreaders 30. The semiconductor devices 10 can be a variety of semiconductor devices such as power MOSFET (i.e., metal-oxide semiconductor field-effect transistors). The semiconductor devices 10 are boarded on the metallic substrate 20 which is made of copper. The heat spreaders 30 are interposed between the semiconductor devices 10 and metallic substrate 20. For convenience, FIG. 1 illustrates the vicinity of one of the semiconductor devices 10 only.

The bonding (i.e., device-side bonding) between the semiconductor devices 10 and heat spreaders 30 is done by solder 41. The bonding (i.e., substrate-side bonding) between the metallic substrate 20 and heat spreaders 30 is done by solder 42. Note that it is possible to carry out bonding by the solder 41 and solder 42 simultaneously as done in brazing. In this Example No. 1, however, the substrate-side bonding is done firs by the solder 42 having a high melting point. Thereafter, the device-side bonding is done by the solder 41 having a low melting point.

The heat spreaders 30 comprise a cladding material. The cladding material comprises a high thermal conductor 31, and a low expander 32 surrounded by the high thermal conductor 31. The high thermal conductor 31 is composed of Cu. The low expander 32 is disposed in the middle of the heat spreaders 30, and is composed of an Fe-36% Ni invar alloy. Therefore, as illustrated in FIG. 1, the heat spreaders 30 are formed as a three-layered construction in the vertical direction as well.

For instance, in Example No. 1, the overall thickness of the heat spreaders 30 was about 1 mm. In the heat spreaders 30, the thickness of the invar alloy was controlled to ⅓ of the overall thickness of the heat spreaders 30, and was accordingly about 0.3 mm. Moreover, the overall width of the heat spreaders 30 was 12 mm, and the width of the invar alloy was 7 mm. The linear expansion coefficients of the heat spreaders 30 were found as follows. At portions immediately above the invar alloy as well as at portions immediately below the invar alloy similarly, the linear expansion coefficient was 10.5 ppm/° C. On the other hand, the heat spreaders 30 which included Cu disposed around the invar alloy as well exhibited an overall linear expansion coefficient of 13.3 ppm/° C. For reference, the linear expansion coefficient of the semiconductor devices 10 was about 4 ppm/° C., and the linear expansion coefficient of the metallic substrate 20 was about 17 ppm/° C.

In Example No. 1, the heat spreaders 30 are bonded with the semiconductor devices 10 at the areas (i.e., device-side bonding surfaces F1) where the linear expansion coefficient is reduced locally. Moreover, when the heat spreaders 30 are bonded with the metallic substrate 20, the areas (i.e., substrate-side bonding areas F2) are utilized where the liner expansion coefficient is enlarged. The arrangement corresponds to disposing the low expanders 32 at positions facing the semiconductor devices 10 and enlarging the substrate-side bonding areas greater than the device-side bonding areas in accordance with the present invention.

It is apparent from Example No. 1 that it is possible to obtain linear expansion coefficients much closer to the linear expansion coefficients, exhibited by the mating members to be bonded therewith, at the respective bonding surfaces even when the heat spreaders 30 are formed as a symmetrical construction vertically as well as horizontally. As a result, the thermal expansion difference between the semiconductor devices 10 and metallic substrate 20 can be relieved more effectively. Specifically, the semiconductor devices 10 and heat spreaders 30 can be inhibited from coming off from the metallic substrate 20. Accordingly, it is possible to secure the boarding stability of the semiconductor devices 10 with respect to the metallic substrate 20 on a higher level.

Note that the heat generated by the semiconductor devices 10 is transmitted to the metallic substrate 20 by way of Cu (i.e., the high thermal conductor 31) which is good in terms of the thermal conductivity. Therefore, it is needles to say that the heat spreaders 30 are ensured that they fully produce the thermal diffusion effect.

### Example No. 2

FIG. 2 illustrates a power module 200 of Example No. 2 according to the present invention. The power module 200 is provided with heat spreaders 230 whose form is varied from that of the heat spreaders 30 in Example No. 1. Note that the like reference numerals designate the same component parts as those of Example No. 1 in the drawing.

In the heat spreaders 230, a high thermal conductor 231 is used whose cross-section is formed as a trapezoid, instead of the rectangular parallel piped high thermal conductor 31 used in Example No. 1. When the disposition of Cu whose linear expansion coefficient is great is thus optimized, it is possible to make the linear expansion coefficients at the device-side bonding surfaces F1 much closer to the linear expansion coefficient of the semiconductor devices 10.

### Example No. 3

FIG. 3 illustrates a major vertical cross-section of a power module 300 according to Example No. 3 of the present invention. The power module 300 comprises semiconductor devices 310, metallic substrates 320, a housing 350, and heat spreaders 330. The substrates 320 are bonded with the semiconductor devices 310 by solder 341. The substrates 320 are boarded on the housing 350 of the power module 300. The heat spreaders 330 are interposed between the substrate 320 and housing 350. For convenience, FIG. 3 illustrates the vicinity of one of the semiconductor devices 310 only. In Example 3, the housing 350 is made of an Al alloy which is good in terms of the thermal conductivity, and functions as a heatsink as well. Note that the power module 300 is enhanced in terms of the radiating ability when it is provided with air-cooling fins around the outer periphery or a coolant is flowed in it to enhance the cooling efficiency, although the arrangements are not depicted in the drawing. Moreover, the housing 350 made of the Al alloy exhibited a linear expansion coefficient of about 24 ppm/° C.

The substrates 320 are a ceramic insulation substrate with double-sided copper-lining, respectively. The ceramic insulation substrate comprises a ceramic plate 321 disposed at the center core, and wiring layers 322, 323 made of copper and disposed on the opposite surfaces of the ceramic plate 321. In addition to copper, the wiring layers 322, 323 can be made of aluminum. Such a ceramic insulation substrate is available under trade names such as “DBA (i.e., Direct Brazed Aluminum)” and “DBC (i.e., Direct Bond Copper).”48

In the same manner as Example No. 1, the heat spreaders 330 comprise a cladding material. The cladding material comprises a high thermal conductor 331, and a low expander 332 surrounded by the high thermal conductor 331. The high thermal conductor 331 is composed of Cu. The low expander 332 is disposed in the middle of the heat spreaders 330, and is composed of an Fe-36% Ni invar alloy.

The bonding (i.e., substrate-side bonding) between the heat spreaders 330 and substrates 320 is done by solder 342. The bonding (i.e., housing-side bonding) between the heat spreaders 330 and housing 350 is done by solder 343. In Example No. 3 as well, the substrates 320 are disposed at the positions facing the low expanders 332, and the housing-side bonding areas (or heatsink-side bonding areas) are enlarged greater than the substrate-side bonding areas. Further, also in Example No. 3, the heat spreaders 330 are bonded with the substrates 320 at the areas (i.e., substrate-side bonding surfaces F1) where the linear expansion coefficient is reduced locally. Furthermore, the heat spreaders 330 are bonded with the housing 350 at the areas (i.e., housing-side bonding areas F2) where the linear expansion coefficient is enlarged. As a result, the difference between the linear expansion coefficients is reduced at the bonding surfaces so that the boarding stability of the substrates 320 with respect to the housing 350 is improved. Moreover, similarly to Example No. 1, the heat generated by the substrate 330 is transmitted to the housing 350 by way of Cu (i.e., the high thermal conductor 331) which is good in terms of the thermal conductivity, and accordingly the heat spreaders 330 are ensured that they fully produce the thermal diffusion effect.

In addition, since highly expensive composite materials, such as CuMo and Al/SiC, have been used as heat spreaders conventionally, they have been inhibited the cost of power modules from reducing. On the contrary, since the above-described composite material used in Example No. 3 is less expensive, it makes the cost reduction of power modules easy.

### Example No. 4

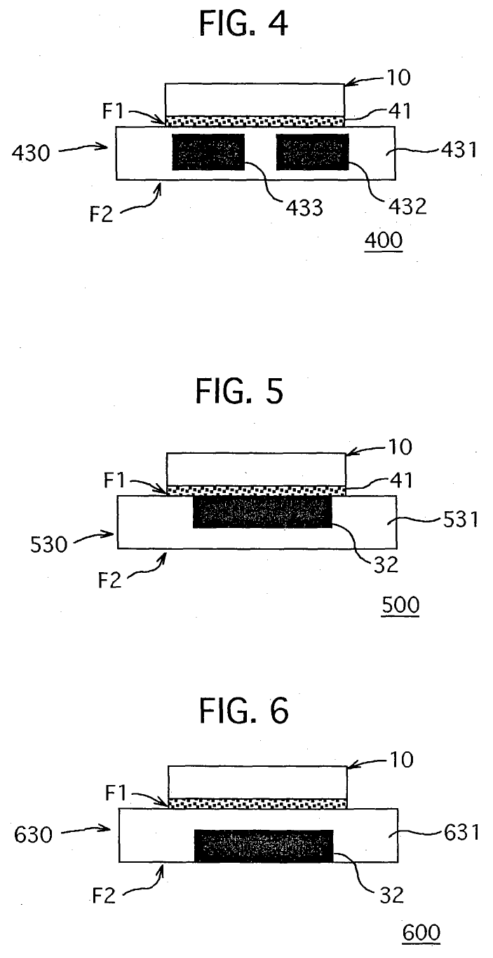

FIG. 4 illustrates a power module 400 of Example No. 4 according to the present invention. The power module 400 is provided with heat spreaders 430 whose form is varied from that of the heat spreaders 30 in Example No. 1. Note that the like reference numerals designate the same component parts as those of Example No. 1 in the drawing.

In the heat spreaders 430, the integral low expander 32 is divided equally into two parts, and the resulting divided low expanders 432, 433 are buried in a high thermal conductor 431.

In this Example No. 4, the high thermal conductor 431 is also extended in the vertical direction immediately below the semiconductors 10. The paths which diffuse the heat generated by the semiconductors 10 to the metallic substrate are increased accordingly by the extension. Therefore, it is possible to more efficiently diffuse and radiate the heat generated by the semiconductors 10 to the metallic substrate 20.

### Example No. 5

FIG. 5 illustrates a power module 500 of Example No. 5 according to the present invention. The power module 500 is provided with heat spreaders 530 whose form is varied from that of the heat spreaders 30 in Example No. 1. Note that the like reference numerals designate the same component parts as those of Example No. 1 in the drawing.

In the heat spreaders 530, the burying position of the low expander 32 is shifted from the inner middle of a high thermal conductor 531 to the device-side bonding surface F1. When the disposition of invar alloys whose linear expansion coefficient is small is thus optimized, it is possible to make the linear expansion coefficient at the device-side bonding surface F1 much closer to the liner expansion coefficient of the semiconductor devices 10.

### Example No. 6

FIG. 6 illustrates a power module 600 of Example No. 6 according to the present invention. The power module 600 is provided with heat spreaders 630 whose form is varied from that of the heat spreaders 30 in Example No. 1. Note that the like reference numerals designate the same component parts as those of Example No. 1 in the drawing.

In the heat spreaders 630, the burying position of the low expander 32 is shifted from the inner middle of a high thermal conductor 631 to the substrate-side bonding surface F2. In this instance, since the volumetric proportion of the high thermal conductor 631 which is present immediately below the semiconductor devices 10 increases, the heat spreaders 630 are further enhanced in terms of the heat diffusing ability. Namely, the heat spreaders 630 are improved in terms of the thermal conductivity so that the temperature is likely to lower.

(Others)

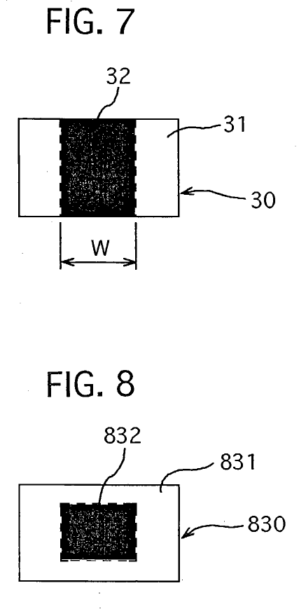

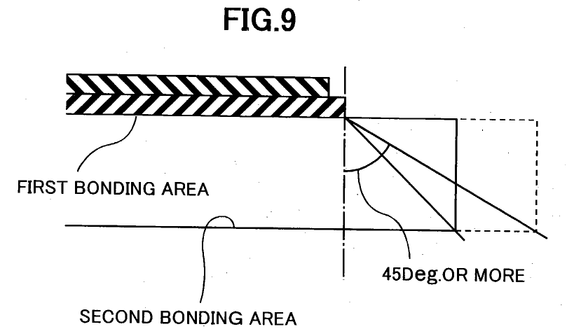

FIG. 7 illustrates another example, and is a horizontal cross-section of the heat spreaders 30 in the power module 100 of Example No. 1 according to the present invention. Here, in accordance with linear expansion coefficients desired at the device-side bonding surface F1, it is possible to determine whether the width W occupied by the low expander 32 in the heat spreaders 30 is wide or narrow with respect to the width of the semiconductor devices 10 to be bonded with the heat spreaders 30. For example, it is possible to control the width W of the low expander 32 in a range of from −60% to +60% with respect to the width of the semiconductor devices 10. Indeed, when the low expander 32 is exposed in the device-side bonding surface F1 as described in Example No. 5, it is needed to narrow the width W of the low expander 32 less than the width of the semiconductor devices 10.

So far, like the heat spreaders 30 illustrated in FIG. 7, the descriptions have been given on the low expander 32 whose opposite ends in vertical cross-section are not necessarily surrounded by the high thermal conductor 31 completely. However, like heat spreaders 830 of Example No. 7 according to the present invention illustrated in FIG. 8, it is needless to say that the entire periphery of a low expander 832 can be surrounded by a high thermal conductor 831 completely. It is preferable to employ such a form because the path in which heat diffuses from the semiconductor devices 10 to the metallic substrate 20 can be expanded. As a result, even in above-described Example No. 5, it is not necessarily required to narrow the width of the low expander 832 less than the width of the semiconductor devices 10.

Having now fully described the present invention, it will be apparent to one of ordinary skill in the art that many changes and modifications can be made thereto without departing from the spirit or scope of the present invention as set forth herein including the appended claims.

What is claimed is:

1. A radiator system, comprising:
a high-temperature body being a thermal source;
a receiver with the high-temperature body boarded thereon, the receiver receiving heat from the high-temperature body; and
a thermal buffer interposed at least between the high-temperature body and the receiver to buffer thermal transmission from the high-temperature body to the receiver;
whereby the heat from the high-temperature body is radiated by the receiver or is radiated by way of the receiver;
wherein the thermal buffer comprises a high thermal conductor, and a low expander disposed at a position facing the high-temperature body and buried in the high thermal conductor; and
the thermal buffer has a first bonding area with respect to the high-temperature body, and a second bonding area with respect to the receiver, the second bonding area being enlarged greater than the first bonding area.

2. The radiator system set forth in claim 1, wherein said thermal buffer comprises the low expander buried in said high thermal conductor and having an outer surface surrounded by the high thermal conductor.

3. The radiator system set forth in claim 1, wherein the low expander comprises a material whose linear expansion coefficient is smaller than that of said high-temperature body.

4. The radiator system set forth in claim 1, wherein the low expander comprises an invar alloy.

5. The radiator system set forth in claim 1, wherein the high thermal conductor comprises a pure metal or alloy whose major component is copper (Cu) or aluminum (Al).

6. The radiator system set forth in claim 1, wherein said receiver comprises a metallic body with a metallic material base.

7. A radiating method for radiating heat from a high-temperature body being a thermal source by a receiver with the high-temperature body boarded thereon, the receiver receiving the heat from the high-temperature body, or radiating the heat by way of the receiver, the radiating method comprising the step of:
preparing a thermal buffer interposed at least between the high-temperature body and the receiver to buffer thermal transmission from the high-temperature body to the receiver,
wherein the thermal buffer comprises a high thermal conductor, and a low expander disposed at a position facing the high-temperature body and buried in the high thermal conductor; and
the thermal buffer has a first bonding area with respect to the high-temperature body, and a second bonding area with respect to the receiver, the second bonding area being enlarged greater than the first bonding area.

8. A thermal buffer interposed at least between a high-temperature body being a thermal source and a receiver with the high-temperature body boarded thereon, the receiver receiving heat from the high-temperature body, to buffer thermal transmission from the high-temperature body to the receiver,
wherein the thermal buffer comprises a high thermal conductor, and a low expander disposed at a position facing the high-temperature body and buried in the high thermal conductor; and
the thermal buffer has a first bonding area positioned with respect to the high-temperature body, and a second bonding area positioned with respect to the receiver, the second bonding area being enlarged greater than the first bonding area.

9. A semiconductor module, comprising:
a semiconductor device being a thermal source;
a substrate with the semiconductor device boarded thereon; and
a heat spreader interposed between the semiconductor device and the substrate to diffuse heat from the semiconductor device to the substrate;
wherein the heat spreader comprises a high thermal conductor, and a low expander disposed at a position facing the semiconductor device and buried in the high thermal conductor; and
the heat spreader has a first bonding area between the heat spreader and the semiconductor device and with respect to the semiconductor device, and a second bonding area between the heat spreader and the substrate and with respect to the substrate, the second bonding area being enlarged greater than the first bonding area.

10. A heat spreader interposed between a semiconductor device being a thermal source and a substrate with the semiconductor device boarded thereon to diffuse heat from the semiconductor device to the substrate,
wherein the heat spreader comprises a high thermal conductor, and a low expander disposed at a position facing the semiconductor device and buried in the high thermal conductor; and
the heat spreader has a first bonding area between the heat spreader and the semiconductor device and with respect to the semiconductor device, and a second bonding area between the heat spreader and the substrate and with respect to the substrate, the second bonding area being enlarged greater than the first bonding area.

11. A semiconductor module, comprising:
a semiconductor device being a thermal source;
a heatsink receiving heat from the semiconductor; and
a substrate having opposite surfaces, bonded to the semiconductor device on one of the opposite surfaces, and bonded to the heatsink on the other one of the opposite surfaces to transmit the heat from the semiconductor device to the heatsink;
wherein the substrate comprises a high thermal conductor, and a low expander disposed at a position facing the semiconductor device and buried in the high thermal conductor; and
the substrate has a first bonding area between the substrate and the semiconductor device and with respect to the semiconductor device, and a second bonding area between the substrate and the heatsink and with respect to the heatsink, the second bonding area being enlarged greater than the first bonding area.

12. A substrate having opposite surfaces, bonded to a semiconductor device being a thermal source on one of the opposite surfaces, and bonded to a heatsink receiving heat from the semiconductor device on the other one of the opposite surfaces to transmit the heat from the semiconductor device to the heatsink,
wherein the substrate comprises a high thermal conductor, and a low expander disposed at a position facing the semiconductor device and buried in the high thermal conductor; and
the substrate has a first bonding area between the substrate and the semiconductor device and with respect to the semiconductor device, and a second bonding area between the substrate and the heatsink and with respect to the heatsink, the second bonding area being enlarged greater than the first bonding area.

13. A semiconductor module, comprising:
a substrate being a thermal source;
a heatsink receiving heat from the substrate; and
a heat spreader having opposite surfaces, bonded to the substrate on one of the opposite surfaces, and bonded to the heatsink on the other one of the opposite surfaces to transmit the heat from the substrate to the heatsink;
wherein the heat spreader comprises a high thermal conductor, and a low expander disposed at a position facing the substrate and buried in the high thermal conductor; and
the heat spreader has a first bonding area between the heat spreader and the substrate and with respect to the substrate, and a second bonding area between the heat spreader and the heatsink and with respect to the heatsink, the second bonding area being enlarged greater than the first bonding area.

14. A heat spreader having opposite surfaces, bonded to a substrate being a thermal source on one of the opposite surfaces, and bonded to a heatsink receiving heat from the substrate on the other one of the opposite surfaces to transmit the heat from the substrate to the heatsink,
wherein the heat spreader comprises a high thermal conductor, and a low expander disposed at a position facing the semiconductor device and buried in the high thermal conductor; and
the heat spreader has a first bonding area between the heat spreader and the substrate and with respect to the substrate, and a second bonding area between the heat spreader and the heatsink and with respect to the heatsink, the second bonding area being enlarged greater than the first bonding area.
